(19) United States
(12) Patent Application Publication
(10) Pub. No.: US 2018/0192342 A1
(43) Pub. Date: Jul. 5, 2018

(54) METHOD FOR CONFIGURING MASS MOBILE BACKHAUL, TRANSMISSION METHOD AND APPARATUS FOR MASS MOBILE BACKHAUL, AND HANDOVER METHOD AND APPARATUS FOR MASS MOBILE BACKHAUL

(71) Applicant: ELECTRONICS AND TELECOMMUNICATIONS RESEARCH INSTITUTE, Daejeon (KR)

(72) Inventors: Soon Yong LIM, Daejeon (KR); Myungsan BAE, Sejong-si (KR); Mi Jeong YANG, Daejeon (KR)

(21) Appl. No.: 15/646,243

(22) Filed: Jul. 11, 2017

(30) Foreign Application Priority Data
Jan. 3, 2017 (KR) 10-2017-0000925

(51) Int. Cl. H04W 36/22; H04W 28/02; H04W 36/08; H04L 12/851; H04W 36/00; H04W 40/36

(52) U.S. Cl. CPC H04W 36/22; H04W 28/0252; H04W 36/08; H04W 84/12; H04W 36/0072; H04W 40/36; H04L 47/24

(57) ABSTRACT

A transmission method of a mobile station moved in a region of a cell provided by a base station and providing a wireless LAN (local area network). The mobile station receives a plurality of uplink packet flows from a terminal. The mobile station distributes the plurality of uplink packet flows to a plurality of carrier components. Further, the mobile station transmits the plurality of uplink packet flows to the base station through the plurality of carrier components.

### CROSS-REFERENCE TO RELATED APPLICATION

This application claims priority to and the benefit of Korean Patent Application No. 10-2017-0000925, filed in the Korean Intellectual Property Office on Jan. 3, 2017, the entire content of which is incorporated herein by reference.

### BACKGROUND OF THE INVENTION

### 1. Field of the Invention

The present invention relates to a method of configuring a mass mobile backhaul.

The present invention also relates to a transmission method and an apparatus for mass mobile backhaul, and a handover method and an apparatus for mass mobile backhaul.

### 2. Description of Related Art

Conventional wireless backhaul is becoming popular for providing a fixed point-to-point service. In recent years, research and development of mobile backhaul have been carried out and a limited service of the mobile backhaul has been accomplished, however capacity of a channel is not very large.

Recently, due to spread of a mobile environment, mass mobile backhaul requiring a transmission speed of a several Gbps level has been required. To meet this requirement, a wideband radio channel must firstly be provided. However, because it is difficult to secure a wideband band in a current frequency domain, research on expanding a band into a millimeter wave (mmWave) frequency domain is underway.

To overcome a limitation of the conventional mobile backhaul, a mobile backhaul system using the millimeter (mmWave) frequency band has been introduced, there is still insufficient capacity.

A conventional art attempts to increase transmission capacity by using a CA (carrier aggregation) technique of aggregating two carriers providing a several hundred Mbps transmission speed. However, to provide a high transmission speed for the mass mobile backhaul reaching several Gbps to tens of Gbps, many carriers must be aggregated by the CA technique. Therefore, because an overload of an aggregation processor performing the CA inside the system faces the limitation, there is a problem that it is difficult to perform the CA.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention provides a method and an apparatus for a high capacity mass mobile backhaul service.

An exemplary embodiment of the present invention provides a transmission method of a mobile station moving in a cell region provided by a base station and providing a wireless LAN (local area network). The transmission method of the mobile station includes: receiving a plurality of uplink packet flows from a terminal; distributing the plurality of uplink packet flows to a plurality of carrier components; and transmitting the plurality of uplink packet flows to the base station through the plurality of carrier components.

The transmission method of the mobile station may further include receiving a plurality of downlink packet flows distributed to the plurality of carrier components by the base station from the base station.

The mobile station may include a plurality of user-plane protocol stacks for the plurality of carrier components.

Each of the plurality of user-plane protocol stacks may include a PDCP (packet data convergence protocol), an RLC (radio link control) protocol, a MAC (medium access control) protocol, and a PHY (physical) protocol.

The plurality of uplink packet flows may pass through the plurality of user-plane protocol stacks, respectively.

The distributing may include maintaining a carrier component for a first uplink packet flow as a first carrier component when the first uplink packet flow among the plurality of uplink packet flows is distributed to the first carrier component among the plurality of carrier components.

A plurality of bearers for communication between the mobile station and the base station and one bearer for communication between a gateway transmitting the plurality of downlink packet flows to the base station and the base station may exist.

A transmission method of a base station providing a cell according to another exemplary embodiment of the present invention is provided. The transmission method of the base station includes: receiving a plurality of downlink packet flows distributed to a plurality of carrier components by a gateway from the gateway; transmitting the plurality of downlink packet flows through the plurality of carrier components to a mobile station providing a wireless LAN (local area network) while moving in a region of the cell; and receiving a plurality of uplink packet flows distributed to the plurality of carrier components by the mobile station from the mobile station.

The base station may include a plurality of user-plane protocol stacks for the plurality of carrier components.

Each of the plurality of user-plane protocol stacks may include a PDCP (packet data convergence protocol), an RLC (radio link control) protocol, a MAC (medium access control) protocol, and a PHY (physical) protocol.

The plurality of downlink packet flows may pass through the plurality of user-plane protocol stacks, respectively.

A plurality of bearers for communication between the mobile station and the base station and a plurality of bearers for communication between the gateway and the base station may exist.

When a first downlink packet flow among the plurality of downlink packet flows is distributed to a first carrier component among the plurality of carrier components, a carrier component for the first downlink packet flow may be maintained as the first carrier component.

A handover method of a target base station according to another exemplary embodiment of the present invention is provided. The handover method of the target base station includes: receiving a plurality of first downlink traffic flows forwarded from a source base station when a mobile station providing a wireless LAN (local access network) hands over from the source base station to the target base station; distributing the plurality of first downlink traffic flows to a plurality of carrier components; and storing a plurality of second downlink traffic flows received from a gateway in a plurality of buffers for the plurality of carrier components.

The distributing may include: receiving a plurality of first end markers representing completion of forwarding of the plurality of first downlink traffic flows from the source base station; and distributing the plurality of first end markers to the plurality of carrier components.

One second end marker may be transmitted from the gateway to the source base station when path switching by the gateway is performed.

The plurality of first end markers may be generated by the source base station based on the second end marker.

The storing may include: receiving the plurality of second downlink traffic flows through a traffic path from the gateway when the traffic path is changed through path switching of the gateway in order for the traffic path to include the target base station; and distributing the plurality of second downlink traffic flows to the plurality of buffers.

The handover method of the target base station may further include transmitting the plurality of second downlink traffic flows stored in the plurality of buffers to the mobile station when completion of downlink transmission for the plurality of first downlink traffic flows is confirmed through the plurality of first end markers.

The mobile station may include a first flow arbiter distributing a plurality of uplink traffic flows received from a terminal to the plurality of carrier components.

The target base station may include a second flow arbiter distributing the plurality of second downlink traffic flows to the plurality of buffers.

A plurality of bearers for communication between the mobile station and the target base station and one bearer for communication between the gateway and the target base station may be generated.

The mobile station may include a first flow arbiter distributing a plurality of uplink traffic flows received from a terminal to the plurality of carrier components.

The gateway may include a second flow arbiter distributing the plurality of second downlink traffic flows to the plurality of carrier components.

A plurality of bearers for communication between the mobile station and the target base station and a plurality of bearers for communication between the gateway and the target base station may be generated.

### BRIEF DESCRIPTION OF THE DRAWINGS

FIG. 1 is a view showing a backhaul system providing mobile backhaul according to an exemplary embodiment of the present invention.

FIG. 2 is a view showing a protocol stack for a radio channel of a cell according to an exemplary embodiment of the present invention.

FIG. 3 is a view showing a backhaul system using a multi-carrier according to an exemplary embodiment of the present invention.

FIG. 4 and FIG. 5 are views showing a structure of a mass mobile backhaul system according to an exemplary embodiment of the present invention.

FIG. 6 and FIG. 7 are views showing a bearer structure according to an exemplary embodiment of the present invention.

FIG. 8 is a view showing a handover method according to an exemplary embodiment of the present invention.

FIG. 9 is a view showing a wireless apparatus (or a communication node) according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In this specification, redundant description of the same constituent elements is omitted.

Also, in this specification, it is to be understood that when one component is referred to as being “connected” or “coupled” to another component, it may be connected or coupled directly to the other component or be connected or coupled to another component with the other component intervening therebetween. On the other hand, in this specification, it is to be understood that when one component is referred to as being “connected or coupled directly” to another component, it may be connected or coupled to the other component without another component intervening therebetween.

It is also to be understood that the terminology used herein is only for the purpose of describing particular embodiments, and is not intended to be limiting of the invention.

Singular forms are to include plural forms unless the context clearly indicates otherwise.

It will be further understood that term “comprises” or “have” used in the present specification specify the presence of stated features, numerals, steps, operations, components, parts, or a combination thereof, but does not preclude the presence or addition of one or more other features, numerals, steps, operations, components, parts, or a combination thereof.

Also, as used herein, the term “and/or” includes any plurality of combinations of items or any of a plurality of listed items. In this specification, “A or B” may include “A”, “B”, or “A and B”.

In addition, in the present specification, a base station (BS) may indicate an advanced base station, a high reliability base station, a node B, an evolved node B (eNodeB), an access point, a radio access station, a base transceiver station, a mobile multihop relay (MMR)-BS, a relay station functioning as a base station, a high reliability relay station functioning as a base station, a repeater, a macro base station, a small base station, and the like, and it may include entire or partial functions of the advanced base station, the high reliability base station, the nodeB, the eNodeB, the access point, the radio access station, the base transceiver station, the MMR-BS, the relay station, the high reliability relay station, the repeater, the macro base station, the small base station, and the like.

Also, in the present specification, a mobile station (MS) may indicate an advanced mobile station, a high reliability mobile station, and the like, and it may include all or partial functions of the advanced mobile station, the high reliability mobile station, and the like.

Hereinafter, a method (hereinafter, “a CB (carrier bundling) method”) increasing a capacity (for example, a channel capacity) by transmitting and dispersing a plurality of traffic flows to a plurality of carriers will be described.

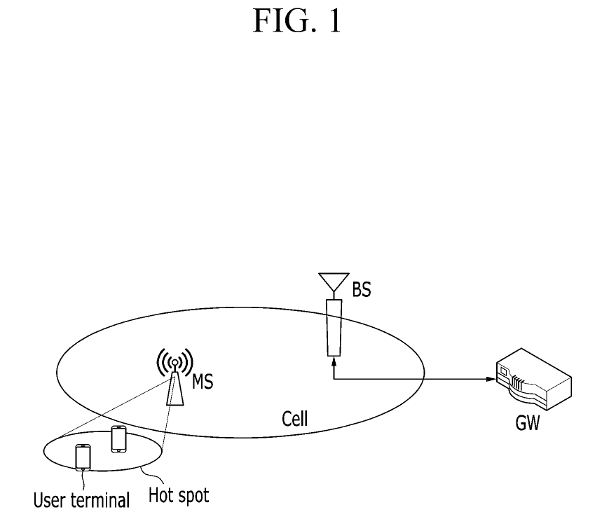

FIG. 1 is a view showing a backhaul system providing mobile backhaul according to an exemplary embodiment of the present invention.

A backhaul system illustrated in FIG. 1 includes a base station BS, a mobile station MS, and a gateway GW.

The base station BS provides a cell by using a radio channel.

The mobile station MS performs data transmission by using the radio channel while moving in the region of the cell provided by the base station BS. In detail, the mobile station MS provides a hotspot. For example, the hotspot provided by the mobile station MS may be a wireless LAN (local access network) using WiFi. A terminal (a user terminal, user equipment) may access the hotspot provided by the mobile station MS.

The gateway GW performs an anchor function of the backhaul system illustrated in FIG. 1. The gateway GW provides an access point of an external data network.

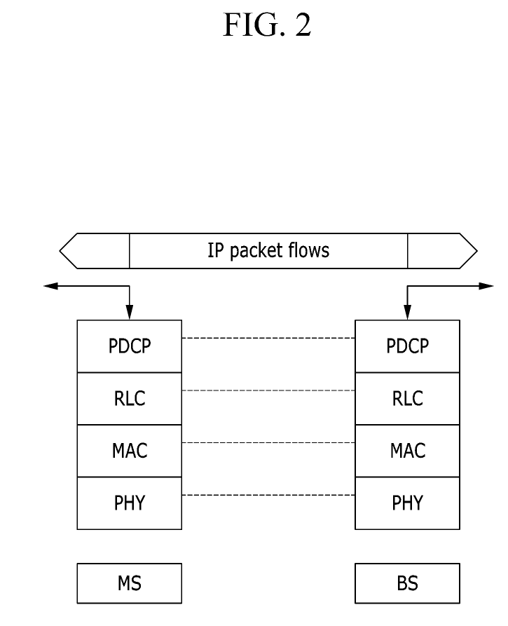

A protocol stack for the radio channel of the cell will be described with reference to FIG. 2.

FIG. 2 is a view showing a protocol stack for a radio channel of a cell according to an exemplary embodiment of the present invention.

In detail, FIG. 2 shows user-plane protocol stack passing user terminal traffic (for example, an IP (internet protocol) packet flow) therethrough. The user-plane protocol stack for the mobile station MS includes a PDCP (packet data convergence protocol), an RLC (radio link control) protocol, a MAC (medium access control) protocol, and a PHY (physical) protocol. The user-plane protocol stack for the base station BS includes the PDCP, the RLC protocol, the MAC protocol, and the PHY protocol.

As the user terminal traffic (for example, the IP packet flow) with the hotspot of the mobile station MS goes through a path such as a user plane illustrated in FIG. 2, communication with the base station BS is obtained.

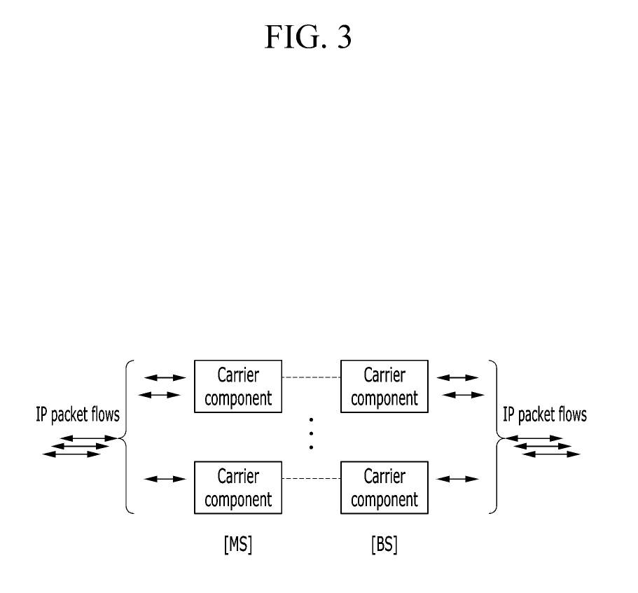

For increasing the capacity of the radio channel, a method of configuring a radio channel period through a plurality of carriers will be described with reference to FIG. 3.

FIG. 3 is a view showing a backhaul system using a multi-carrier according to an exemplary embodiment of the present invention.

A carrier component (CC) is an entity that processes a wireless function limited to the carrier.

The plurality of IP packet flows may be dispersed to a plurality of carrier components CC to be transmitted. This may allow load dispersion to occur. For example, the mobile station MS and the base station BS may allocate the plurality of IP packet flows to the plurality of carrier components, respectively.

On the other hand, when a plurality of carrier components are disposed according to a conventional art, the aggregation of the CA is performed in the RLC, and a bearer split and a bearer merge of DC (dual connectivity) are performed in the PDCP. In this case, sequence management for a packet passing the plurality of carrier components is performed in one layer. Accordingly, if a number of the carrier components increases, a width of the sequence increases such that a limitation of the capacity of the corresponding layer occurs.

1. System Structure

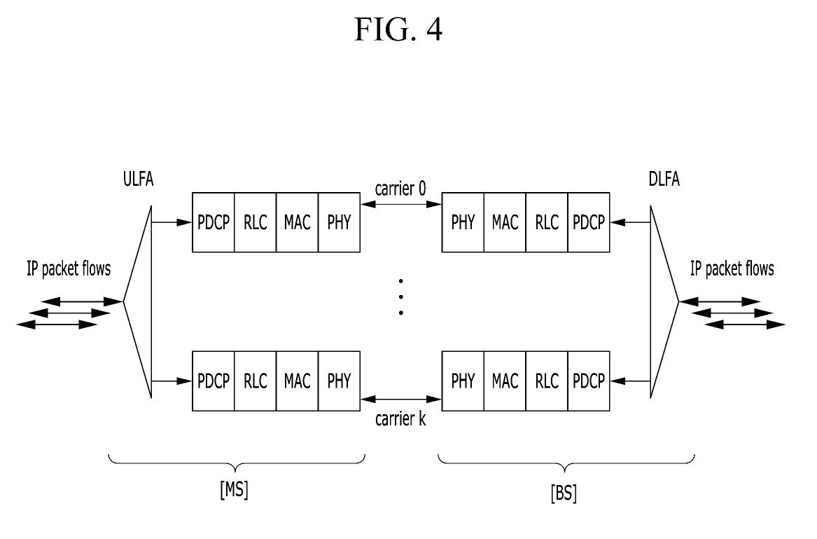

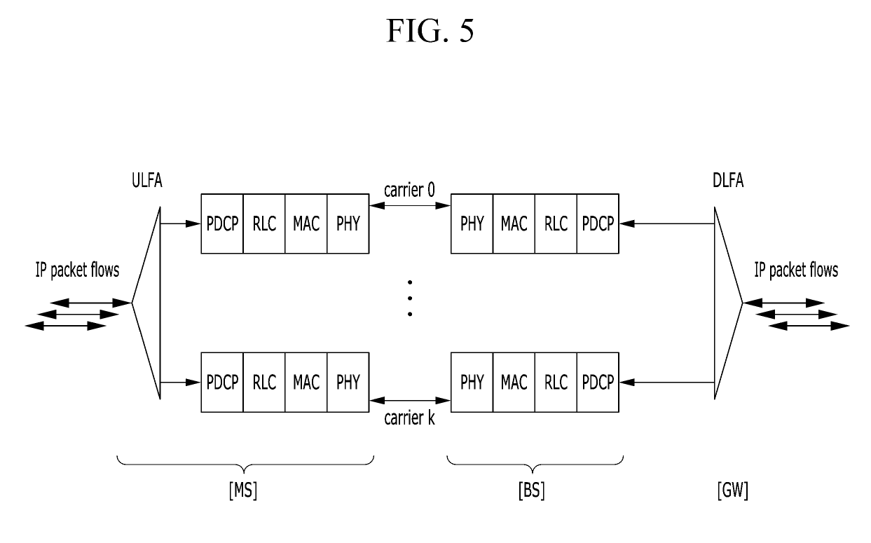

Hereinafter, a method of dispersing traffic (or a traffic flow) to prevent the entire sequence from being managed in one layer, by breaking away the conventional art, will be described. For this, the structure of the mobile backhaul may be of two kinds as illustrated in FIG. 4 and FIG. 5.

FIG. 4 and FIG. 5 are views showing a structure of a mass mobile backhaul system according to an exemplary embodiment of the present invention.

The mobile backhaul according to an exemplary embodiment of the present invention includes a flow arbiter (FA) of two kinds. In detail, the mobile backhaul includes an uplink flow arbiter (ULFA: uplink FA) and a downlink flow arbiter (DLFA: downlink FA).

In the structure (hereinafter, “a first backhaul system structure”) of the backhaul system illustrated in FIG. 4, the ULFA is disposed in the mobile station MS and the DLFA is disposed in the base station BS.

In the backhaul system structure (hereinafter, “a second backhaul system structure”) illustrated in FIG. 5, the ULFA is disposed in the mobile station MS and the DLFA is disposed in the gateway GW.

The ULFA performs a function of distributing (or allocating) a plurality of uplink IP packet flows of the user terminal to the plurality of carrier components.

The DLFA performs a function of distributing (or allocating) a plurality of downlink IP packet flows (or a plurality of downlink traffic flows) transmitted from a network to the user terminal to the plurality of carrier components.

For example, in the first backhaul system structure, the mobile station MS receives the plurality of uplink IP packet flows (or a plurality of uplink traffic flows) from the user terminal, and the ULFA of the mobile station MS may disperse and allocate the plurality of uplink IP packet flows to the plurality of carrier components for the plurality of carriers (for example, (k+1) carriers (a carrier 0 to a carrier k)). The mobile station MS may transmit the plurality of uplink IP packet flows to the base station BS through the plurality of carrier components. In the first backhaul system structure, when the base station BS receives the plurality of downlink IP packet flows for the user terminal from the gateway GW, the DLFA of the base station BS may disperse and allocate the plurality of downlink IP packet flows to the plurality of carrier components for the plurality of carriers (for example, the (k+1) carriers (the carrier 0 to the carrier k)). The base station BS may transmit the plurality of downlink IP packet flows to the mobile station MS through the plurality of carrier components.

As another example, in the second backhaul system structure, the ULFA of the mobile station MS may disperse and allocate the plurality of uplink IP packet flows to the plurality of carrier components for the plurality of carriers (for example, the (k+1) carriers (the carrier 0 to the carrier k)). The base station BS may receive the plurality of uplink IP packet flows disposed in the plurality of carrier components from the mobile station MS. In the second backhaul system structure, the DLFA of the gateway GW may disperse and allocate the plurality of downlink IP packet flows to the plurality of carrier components for the plurality of carriers (for example, the (k+1) carriers (the carrier 0 to the carrier k)). When the base station BS receives the plurality of downlink IP packet flows distributed to the plurality of carrier components from the gateway GW, the base station BS may transmit the plurality of downlink IP packet flows to the mobile station MS through the plurality of carrier components.

In the first backhaul system structure or the second backhaul system structure, the IP packet flow allocated in each carrier component goes through the user-plane protocol stack (the PDCP, the RLC, the MAC, and the PHY) for the mobile station MS and the user-plane protocol stack (the PDCP, the RLC, the MAC, and the PHY) for the base station BS. Here, a user-plane protocol stack for each carrier component may exist. For example, when the number of carrier components is (k+1), (k+1) user-plane protocol stacks may exist. Each IP packet flow may pass through each user-plane protocol stack.

On the other hand, because the FA (for example, the ULFA or the DLFA) is a one-way function processor, the traffic (or the IP packet flow) of an opposite direction penetrates without being distributed to the carrier component. For example, the ULFA penetrates the downlink IP packet flow without being distributed, and the DLFA penetrates the uplink IP packet flow without being distributed.

The FA (for example, the ULFA or the DLFA) consistently distributes the specific IP packet flow to the specific carrier component to maintain the specific carrier component for the specific IP packet flow. For example, when a first IP packet flow among the plurality of IP packet flows is distributed to a first carrier component among the plurality of carrier components, the carrier component for the first IP packet flow may be maintained as the first carrier component.

2. Bearer Structure

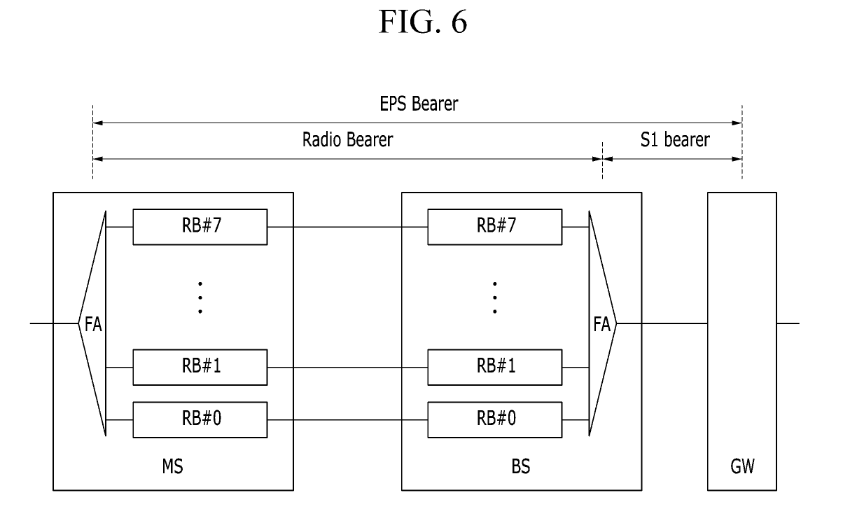

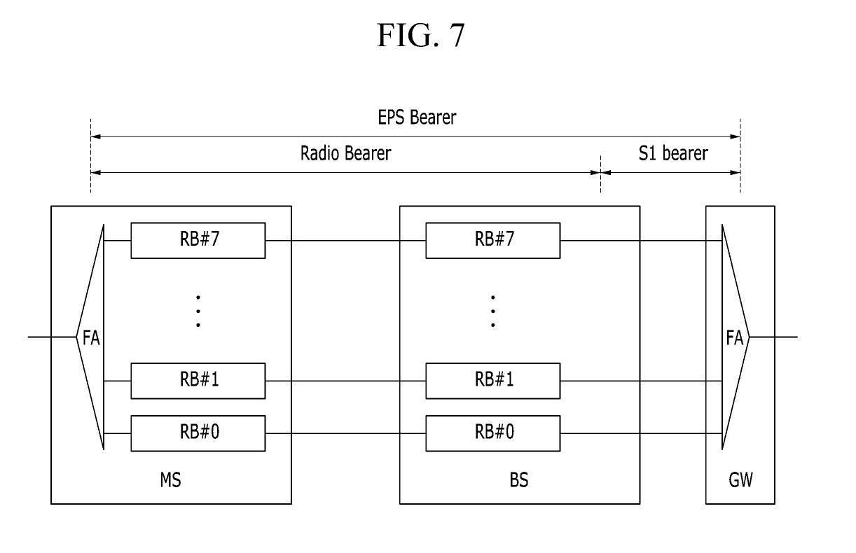

According to the above-described backhaul system structure (for example, the first backhaul system structure or the second backhaul system structure), the bearer structure may be of two kinds as illustrated in FIG. 6 and FIG. 7.

FIG. 6 and FIG. 7 are views showing a bearer structure according to an exemplary embodiment of the present invention.

The bearer structure (hereinafter, “a first bearer structure”) illustrated in FIG. 6 is used (or generated) for the first backhaul system structure. The first bearer structure includes one EPS (evolved packet switched system) bearer, one S1 bearer attached to the EPS bearer, and radio bearers (RB #0, RB #1, . . . , RB #7) attached to the EPS bearer. Here, the number of the radio bearers may be changed depending on the number of carrier components used. In the first bearer structure, one EPS bearer represents a tunnel generated between the mobile station MS and the gateway GW, eight radio bearers (RB #0-RB #7) represent bearers for the communication between the mobile station MS and the base station BS, and the S1 bearer represents a bearer for communication between the base station BS and the gateway GW.

The bearer structure (hereinafter, “a second bearer structure”) illustrated in FIG. 7 is used (or generated) for the second backhaul system structure. The second bearer structure includes one EPS bearer, eight S1 bearers attached to the EPS bearer, and eight radio bearers (RB #0 to RB #7) attached to the EPS bearer. Here, the number of the radio bearers and the number of the S1 bearers may be changed depending on the number of carrier components used. In the second bearer structure, one EPS bearer represents a tunnel generated between the mobile station MS and the gateway GW, eight radio bearers (RB #0-RB #7) represent bearers for the communication between the mobile station MS and the base station BS, and eight S1 bearers represent bearers for communication between the base station BS and the gateway GW.

3. Handover (HO: Handover) Structure

Hereinafter, a case in which a handover is generated will be described.

A handover method will be described as an example of the first backhaul system structure among the above-described backhaul system structures (the first backhaul system structure and the second backhaul system structure). However, this is only an example, and the handover method for the second backhaul system structure may apply the handover method for the first backhaul system structure in the same method.

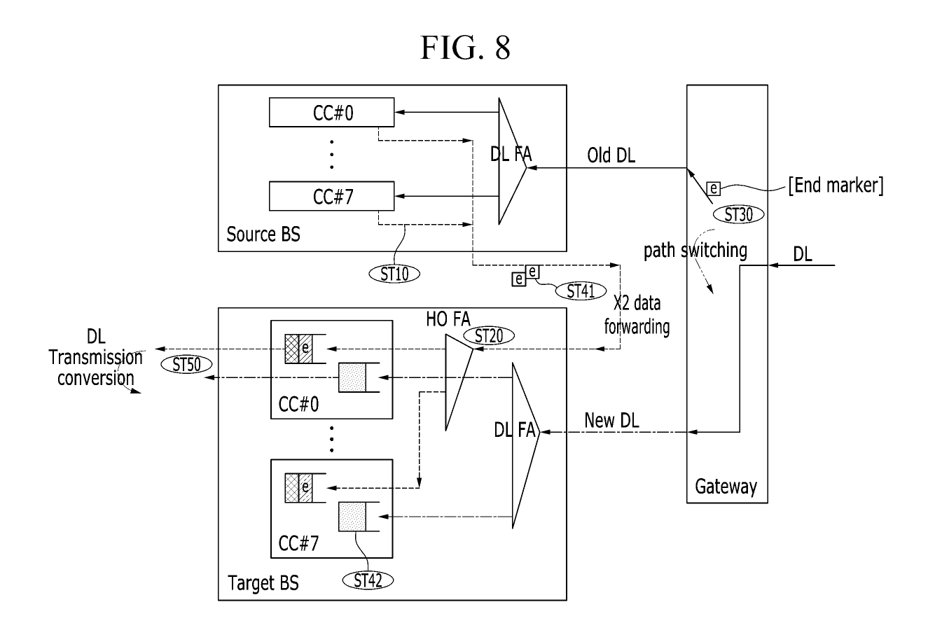

FIG. 8 is a view showing a handover method according to an exemplary embodiment of the present invention.

In detail, FIG. 8 illustrates a case in which eight carrier components (CC #0, CC #1, . . . , CC #7) are used.

When the handover is started such that the mobile station MS is moved from a source base station (a source BS) to a target base station (a target BS), the downlink traffic (or the IP packet flow) that has stayed at the source BS is forwarded to the target BS (ST10).

The target BS distributes the forwarded downlink traffic flows (or the IP packet flows) to the plurality of carrier components (CC #0-CC #7) (ST20). In detail, a HOFA (handover FA) disposed on the target BS may distribute the plurality of forwarded traffic flows (or the plurality of IP packet flows) to the plurality of carrier components CC #0-CC #7. Downlink transmission for the traffic distributed to each carrier component (CC #0-CC #7) is performed. That is, the target BS may transmit the traffic distributed to each carrier component (CC #0-CC #7) to the mobile station MS.

As a part of the handover process, if path switching is generated (performed) by the gateway GW, the gateway GW transmits an end marker to the source BS and changes a path S1 (ST30). In detail, the gateway GW connects the path S1 (or a traffic path) to the target BS. That is, in order for the path S1 to include the target BS, the path S1 may be changed through the path switching of the gateway GW.

When the source BS receives the end marker, the DLFA of the source BS generates eight (or eight kinds of) end markers for eight carrier components (CC #0-CC #7) by using the received end marker (ST41). Here, eight end markers represent that the traffic forwarding from the source BS to the target BS is completed. Accordingly, the end marker for each of eight carrier components (CC #0-CC #7) may be inserted at the end of the forwarded traffic. That is, in order to insert the end marker to each of eight carrier components (CC #0-CC #7), the DLFA of the source BS may expand and produce the end marker. In this way, the reproduced (expanded and produced) eight end markers are transmitted to the HOFA of the target BS through the data forwarding (for example, X2 data forwarding). Also, though the distribution by the HOFA of the target BS, eight end markers are transmitted to eight carrier components (CC #0-CC #7), respectively.

While the data forwarding (for example, the X2 data forwarding) is performed, the downlink traffic transmitted through the new path S1 (the path S1 generated by the path switching of the gateway GW) is stored in a buffer for each of the carrier components (CC #0-CC #7) of the target BS (ST42). In detail, the DLFA of the target BS may distribute the downlink traffic flows transmitted from the gateway GW through the path S1 to eight buffers for eight carrier components (CC #0-CC #7). The downlink transmission for the downlink traffic stored in the buffer is temporarily not performed.

When the target BS confirms the end marker, the downlink transmission of the data (the downlink traffic) temporarily stored in eight buffers for eight carrier components (CC #0-CC #7) is started (ST50). In detail, when the target BS confirms the completion of the downlink transmission of the traffic forwarded from the source BS through the end marker (for example, the end marker for each of the carrier components (CC #0-CC #7)), downlink transmission conversion may be performed to perform the downlink transmission of the traffic stored in each buffer. That is, the target BS may transmit the traffic stored in each buffer to the mobile station MS.

The target BS closes the handover process.

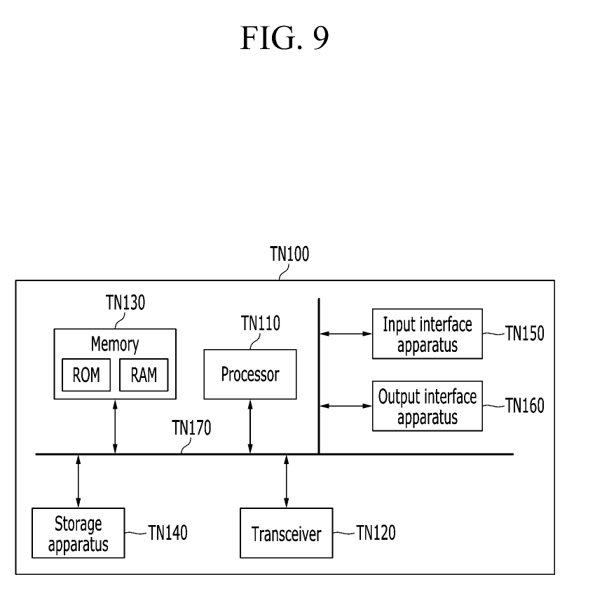

FIG. 9 is a view showing a wireless apparatus (or a communication node) according to an exemplary embodiment of the present invention. A wireless apparatus TN100 of FIG. 9 may be the base station BS, the mobile station MS, the user terminal, the gateway GW, etc., described in the present specification, or a transmitter or a receiver.

In an exemplary embodiment of FIG. 9, the wireless apparatus TN100 may include at least one processor TN110, a transceiver TN120 connected to the network and performing communication, and a memory TN130. The wireless apparatus TN100 may further include a storage apparatus TN140, an input interface apparatus TN150, an output interface apparatus TN160, etc. The constituent elements included in the wireless apparatus TN100 are connected to each other by a bus TN170 to perform the communication with each other.

The processor TN110 may execute a program command stored in at least one of the memory TN130 and the storage apparatus TN140. The processor TN110 may be a central processing unit (CPU), a graphics processing unit (GPU), or a dedicated processor performing the methods according to an exemplary embodiment of the present invention. The processor TN110 may be configured to realize the procedure, the function, and the methods that are described in relation to an exemplary embodiment of the present invention. The processor TN110 may control each constituent element of the wireless apparatus TN100.

Each of the memory TN130 and the storage apparatus TN140 may store various information related to the operation of the processor TN110. Each of the memory TN130 and the storage apparatus TN140 may be composed of at least one of a volatile storage medium and a non-volatile storage medium. For example, the memory TN130 may be composed of at least one of a read-only memory (ROM) and a random access memory (RAM).

The transceiver TN120 may transmit and receive a wire signal or a wireless signal. Further, the computing apparatus TN100 may have a single antenna or a multi-antenna.

According to an exemplary embodiment of the present invention, the mass mobile backhaul (or a mass mobile backhaul service) satisfying high capacity requirements may be provided.

The exemplary embodiments of the present invention are not only embodied by the above-mentioned method and apparatus. Alternatively, the above-mentioned exemplary embodiments may be embodied by a program performing functions that correspond to the configuration of the exemplary embodiments of the present invention, or a recording medium on which the program is recorded. These embodiments can be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A transmission method of a mobile station moving in a region of a cell provided by a base station and providing a wireless LAN (local area network), the transmission method comprising:
receiving a plurality of uplink packet flows from a terminal;
distributing the plurality of uplink packet flows to a plurality of carrier components; and
transmitting the plurality of uplink packet flows to the base station through the plurality of carrier components.

2. The transmission method of claim 1, further comprising receiving a plurality of downlink packet flows distributed to the plurality of carrier components by the base station from the base station.

3. The transmission method of claim 1, wherein:
the mobile station includes a plurality of user-plane protocol stacks for the plurality of carrier components,
each of the plurality of user-plane protocol stacks includes a PDCP (packet data convergence protocol), an RLC (radio link control) protocol, a MAC (medium access control) protocol, and a PHY (physical) protocol, and
the plurality of uplink packet flows pass through the plurality of user-plane protocol stacks, respectively.

4. The transmission method of claim 1, wherein the distributing includes maintaining a carrier component for a first uplink packet flow as a first carrier component when the first uplink packet flow among the plurality of uplink packet flows is distributed to the first carrier component among the plurality of carrier components.

5. The transmission method of claim 2, wherein a plurality of bearers for communication between the mobile station and the base station and one bearer for communication between a gateway transmitting the plurality of downlink packet flows to the base station and the base station exist.

6. A transmission method of a base station providing a cell, the transmission method comprising:
receiving a plurality of downlink packet flows distributed to a plurality of carrier components by a gateway from the gateway;
transmitting the plurality of downlink packet flows through the plurality of carrier components to a mobile station providing a wireless LAN (local area network) while moving in a region of the cell; and
receiving a plurality of uplink packet flows distributed to the plurality of carrier components by the mobile station from the mobile station.

7. The transmission method of claim 6, wherein:
the base station includes a plurality of user-plane protocol stacks for the plurality of carrier components,
each of the plurality of user-plane protocol stacks includes a PDCP (packet data convergence protocol), an RLC (radio link control) protocol, a MAC (medium access control) protocol, and a PHY (physical) protocol, and
the plurality of downlink packet flows pass through the plurality of user-plane protocol stacks, respectively.

8. The transmission method of claim 6, wherein a plurality of bearers for communication between the mobile station and the base station and a plurality of bearers for communication between the gateway and the base station exist.

9. The transmission method of claim 6, wherein when a first downlink packet flow among the plurality of downlink packet flows is distributed to a first carrier component among the plurality of carrier components, a carrier component for the first downlink packet flow is maintained as the first carrier component.

10. A handover method of a target base station, the handover method comprising:
receiving a plurality of first downlink traffic flows forwarded from a source base station when a mobile station providing a wireless LAN (local access network) hands over from the source base station to the target base station;
distributing the plurality of first downlink traffic flows to a plurality of carrier components; and
storing a plurality of second downlink traffic flows received from a gateway in a plurality of buffers for the plurality of carrier components.

11. The handover method of claim 10, wherein the distributing includes:
receiving a plurality of first end markers representing completion of forwarding of the plurality of first downlink traffic flows from the source base station; and
distributing the plurality of first end markers to the plurality of carrier components.

12. The handover method of claim 11, wherein:
one second end marker is transmitted from the gateway to the source base station when path switching by the gateway is performed, and
the plurality of first end markers are generated by the source base station based on the second end marker.

13. The handover method of claim 10, wherein the storing includes:
receiving the plurality of second downlink traffic flows through a traffic path from the gateway when the traffic path is changed through path switching of the gateway in order for the traffic path to include the target base station; and
distributing the plurality of second downlink traffic flows to the plurality of buffers.

14. The handover method of claim 11, further comprising transmitting the plurality of second downlink traffic flows stored in the plurality of buffers to the mobile station when completion of downlink transmission for the plurality of first downlink traffic flows is confirmed through the plurality of first end markers.

15. The handover method of claim 10, wherein:
the mobile station includes a first flow arbiter distributing a plurality of uplink traffic flows received from a terminal to the plurality of carrier components, and
the target base station includes a second flow arbiter distributing the plurality of second downlink traffic flows to the plurality of buffers.

16. The handover method of claim 15, wherein a plurality of bearers for communication between the mobile station and the target base station and one bearer for communication between the gateway and the target base station are generated.

17. The handover method of claim 10, wherein:
the mobile station includes a first flow arbiter distributing a plurality of uplink traffic flows received from a terminal to the plurality of carrier components, and
the gateway includes a second flow arbiter distributing the plurality of second downlink traffic flows to the plurality of carrier components.

18. The handover method of claim 17, wherein a plurality of bearers for communication between the mobile station and the target base station and a plurality of bearers for communication between the gateway and the target base station are generated.
